(19) United States
(12) Patent Application Publication
(10) Pub. No.: US 2026/0203589 A1
(43) Pub. Date: Jul. 16, 2026

(54) LARGE LANGUAGE MODEL (LLM)-GUIDED BAYESIAN CAUSAL DISCOVERY

(71) Applicant: Adobe Inc., San Jose, CA (US)

(72) Inventors: Atanu R. SINHA, Karnataka (IN); Prakhar Verma, Dehradun (IN); Harshita Chopra, Delhi (IN); David Thomas Arbour, Charlottesville, VA (US); Sunav Choudhary, San Jose, CA (US)

(21) Appl. No.: 19/020,865

(22) Filed: Jan. 14, 2025

(51) Int. Cl. G06N 3/0895

(52) U.S. Cl. CPC G06N 3/0895

(57) ABSTRACT

Causal discovery is enhanced using large language models (LLMs). A causal graphical representation, such as a partial ancestral graph, can be generated from a dataset. An LLM is prompted to identify a confounder variable for the causal graphical representation. The confounder variable may be proposed by the LLM so that it has a direct relationship with two variables of the causal graphical representation initially having a dependent relationship identified from a bidirectional edge in the graph. The LLM is also prompted to provide a value for the confounder variable. The relationship strength between the confounder variable and another variable in the causal graphical representation is learned by parameter optimization using the value.

### BACKGROUND

Causal discovery is a field of study that focuses on identifying and understanding causal relationships among multiple variables in a dataset. Unlike traditional causal inference, which often relies on predefined treatments and outcomes, causal discovery aims to uncover these relationships in a data-driven manner. Traditional methods often rely on the assumption that all relevant variables are observable. The goal of causal discovery is to understand causality within an entire system of variables, which can be visualized using causal graphs. These graphs help in identifying direct and indirect causal effects, thereby providing a comprehensive understanding of the underlying causal mechanism.

Large Language Models (LLMs) are artificial intelligence systems designed to understand, generate, and modify natural language. These models are typically trained on vast datasets comprising text from diverse sources, enabling them to perform a wide range of language-related tasks such as translation, summarization, and question answering. Some LLMs can be trained or fine-tuned for specific applications. LLMs utilize deep learning techniques, such as transformer architectures, to achieve high levels of accuracy in natural language processing. The capabilities of LLMs stem from their ability to learn from extensive amounts of data, allowing them to recognize patterns and generate contextually relevant text.

### SUMMARY

The present technology generally relates to generating and analyzing causal graphical representations using a large language model (LLM). One example method begins by generating a causal graphical representation from a dataset. Subsequently, the LLM is prompted to identify a confounder variable for the causal graphical representation. The confounder variable can include a new or otherwise latent variable with direct relationships to other variables within the causal graphical representation. The LLM is further prompted to provide a value for this variable, such as a mean and standard deviation for the distribution of the variable. Using the provided value, the relationship strength between the confounder variable and another variable in the causal graphical representation is learned through parameter optimization. In an aspect, the relationship strengths between all of the variables within the causal graphical representation, including the confounder variable(s), is learned through the parameter optimization process.

In aspects where the causal graphical representation includes a bidirectional edge between two variables, the confounder variable may be identified as having a dependent relationship with these variables. In some aspects, the LLM can output a second causal graphical representation that includes the confounder variable and identifies its dependent relationships with other variables. When generating the second causal graphical representation, the LLM maintains known dependent relationships within the causal graphical representation. In an aspect, the causal graphical representation is a partial ancestral graph.

This technology addresses several challenges in causal discovery, including the identification of hidden confounder variables and permitting some error when determining values for such variables, thus allowing the incorporation of knowledge from LLMs to learn directed acyclic graph (DAG) parameters, e.g., help determine the relationship strength between variables. By leveraging the knowledge of LLMs, the proposed method enhances the accuracy and robustness of causal discovery, thereby improving processes in various applications relying on such relationships.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which the technology may be employed, in accordance with an aspect described herein;

FIG. 2 illustrates an example causal graphical representation generated from a dataset, in accordance with an aspect described herein;

FIG. 3 illustrates an example causal graphical representation generated using an LLM, in accordance with an aspect described herein;

FIG. 4 illustrates an example in which a value for a confounder variable is provided by an LLM, in accordance with an aspect described herein;

FIG. 5 illustrates an example parameter optimization, in accordance with an aspect described herein;

FIG. 6 illustrates an example method of causal discovery, in accordance with an aspect described herein; and

FIG. 7 illustrates an example computing device suitable for implementing aspects of the technology, in accordance with an aspect described herein.

### DETAILED DESCRIPTION

### Definitions

Various terms are used throughout this description. Definitions of some terms are included below to provide a clearer understanding of the ideas disclosed herein.

As used herein, “causal graphical representation” describes a representation of a causal graph, including a graph or structured dataset relationships from which a graph may be generated that indicates relationships between variables of a dataset. In graphical form, the causal graphical representation may include nodes corresponding to variables of the dataset and edges between nodes that represent the relationship between the variables. For instance, a causal graphical representation may take the form of a partial ancestral graph (PAG). Additional examples that may be suitable include direct acyclic graphs (DAGs), causal Bayesian networks, directed cyclic graphs (DAGs), and the like.

A “bidirectional edge” generally describes an edge between two variables of the causal graphical representation that indicates an unknown relationship between the two variables. For instance, a change in the value of one variable causes an undetermined change to the other variable. A bidirectional edge between variables can sometimes indicate that there is another intermediary variable (a latent confounder variable) between the two variables that affects the value change to one variable when the value of the other variable changes.

A “confounder variable” is generally used to describe a latent variable that has a relationship between other variables of the causal graphical representation. The latent variable typically influences both the cause and effect of variable values but is not observed in the dataset. The presence of confounder variables could lead to incorrect inferences about causal relationships if not accounted for. As an example, a botanical dataset may include variables such as “flower color” and “flower size,” and values for these variables. However, these variables may be dependent on an unmeasured or otherwise not present variables, “soil quality.” Thus, the variable “soil quality” could be considered a latent confounder variable for the botanical dataset, since “soil quality” affects the observed relationship between “flower color” and “flower size.”

A “dependent relationship” is generally used to describe a relationship between two variables where the value of one variable depends on the value of another variable. For instance, changes in the value of one variable will result in changes to the value of the other variable, indicating a dependency between the two variables. Dependent relationships may be direct or indirect. For example, in the botanical dataset, the amount of sunlight a flower receives (variable A) directly affects its growth rate (variable B). Here, the growth rate of the flower depends on the amount of sunlight it receives, illustrating a type of dependent relationship between the two variables.

A “direct relationship” generally refers to a type of dependent relationship between variables where one variable directly influences the other without another intermediary variable. This means that changes in the value of a cause variable will directly result in changes to the value of an effect variable. For example, if variable A and B have a direct relationship and A causes B, then a change in A will directly affect B without any other variables mediating this effect. For instance, in the botanical dataset, the amount of water a flower receives (variable A) directly affects its growth rate (variable B). Here, the growth rate of the flower is directly influenced by the amount of water it receives, illustrating a direct relationship.

“Relationship strength” generally describes the magnitude by which the change in one variable affects another variable. Generally, relationship strength quantifies the degree of influence one variable has on another, providing insights into the strength and direction of the causal relationship between variables

### Overview

Causal discovery methods generally seek to understand the relationship within data. These methods can be computationally expensive or prohibitive, particularly when using a brute force method of variable and relationship discovery. The complexity of a dataset can make it challenging, if not nearly impossible, to understand how variables within the data are related. As the number of variables increases, the complexity of the causal discovery process grows exponentially. This makes it computationally intensive and difficult to scale. High-dimensional data also increases the risk of overfitting, where the model captures noise rather than the underlying causal relationships.

Further problems in causal discovery include the identifiability of causal structures. Identifiability refers to the ability to uniquely determine the causal relationships from the data. In many cases, the data may not provide enough information to distinguish between different causal models, leading to ambiguity. This is particularly problematic when dealing with latent confounders—variables that influence the cause and effect of variable values but are not observed in the dataset. The presence of hidden confounders can lead to incorrect inferences about causal relationships.

The technology described here solves these problems by leveraging the use of LLMs to identify latent confounders, refine causal relationships (e.g., identify or otherwise determine unknown relationships between variables), propose distribution and parameters as initial values for a latent confounder variable, which can then be used to optimize the parameters that determine how one variable affects another, e.g., the relationship strength between variables.

One example method initially generates a causal graphical representation for a dataset. The dataset may be from any domain. The causal graphical representation may be in graphical or structured data form. When in graphical form, the causal graphical representation can be generated by adopting each variable as a node, and connecting the nodes by edges. Some example causal graphical representations might include partial ancestral graphs, directed acyclic graphs (DAGs), causal Bayesian networks, directed cyclic graphs (DCGs), other ancestral graphs, and the like. Edges between the nodes can be used to represent the relationship between variables, including known or unknown aspects about the relationship. In some aspects, a relationship between variables may be unknown, such that a change in value of one variable produces an unknown change in another. When using partial ancestral graphs, this relationship may be represented using bidirectional edge.

For those variables having a bidirectional edge, an LLM can be prompted to output a confounder variable with a relationship to the two variables (nodes) connected by a bidirectional edge. In doing so, the LLM may generate a second causal graphical representation, which includes the latent confounder variable along with the variables (nodes) of the first, or initial, causal graphical representation.

In some cases, the confounder variable provided by the LLM does not have corresponding data in the dataset. As such, the LLM can be further prompted to provide a value for this variable. Accordingly, this value may be provided based on the LLM's training or other data accessible by the LLM. In some aspects, the value provided by the LLM, responsive to the prompt is a mean and standard deviation as parameters of the distribution of the confounder variable.

Using the provided value, parameter optimization methods can be performed to understand the relationship between the variables, including the relationship strength between particular variables, which may include how and to what degree one variable is affected by a change in the value of another. For instance, the relationship strength between the confounder variable and another variable may be learned. In an aspect, the relationship strengths between all of the variables within the causal graphical representation, including the confounder variable(s), is learned through the parameter optimization process.

This method, and others that will be described in more detail, solve many of the problems within causal discovery. Using a brute force method of causal discovery, the computer must explore a vast number of possible variables and their relationships to identify latent variables. This process is computationally expensive because it involves numerous operations, including generating potential causal graphs, evaluating their fit to the data, and iterating through countless combinations of variables. Each of these steps requires substantial read-write operations, which can be time-consuming and resource-intensive, especially with large datasets.

However, by proposing a latent variable and its value using an LLM, the process can be streamlined, as it now has a starting point determined by the knowledge and sophistication of the LLM. When a latent variable and its value are proposed, the computer no longer needs to exhaustively search through all possible variables and their combinations. Instead, it can focus on optimizing the causal graph based on the provided latent variable and its value. This targeted approach reduces the number of operations required, as the computer can bypass the initial exploratory phase and directly work on refining the causal relationships involving the proposed latent variable.

This method leads to fewer read-write operations because the computer is not repeatedly accessing and modifying the dataset to test different combinations. Thus, using an LLM to identify the latent confounder and an associated value doesn't simply perform an existing method faster, but instead, leverages new technology to cause the computer to perform a more focused set of operations. This reduction in operations translates to lower computational costs and faster processing times.

An additional advantage of the technology is improved causal discovery when “expert” is noisy. Traditionally, the use of information from a human expert is done, and it is assumed that human input information is correct. However, the use of methods described herein can be performed when there is error in determining values for latent variables, therefore allowing the “expert” to be fallible, and permitting the use of LLM in causal discovery, breaking away from the strong assumption of an oracle human expert, yet recovering the correct relations and obtaining good estimators of edge weights.

Moreover, the use of LLMs to propose a latent confounder variable and a value for it is not a well-understood, routine, or conventional technique within causal discovery. Further, the combination of using an LLM to modify a causal graphical representation in combination with performing parameter optimization on the modified causal graphical representation is not a well-understood, routine, or conventional activity within causal discovery.

### Example Causal Discovery System

It will be realized that the methods previously described are only examples that can be practiced from the description that follows, and the examples are provided to more easily understand the technology and recognize its benefits. Additional examples are now described with reference to the figures.

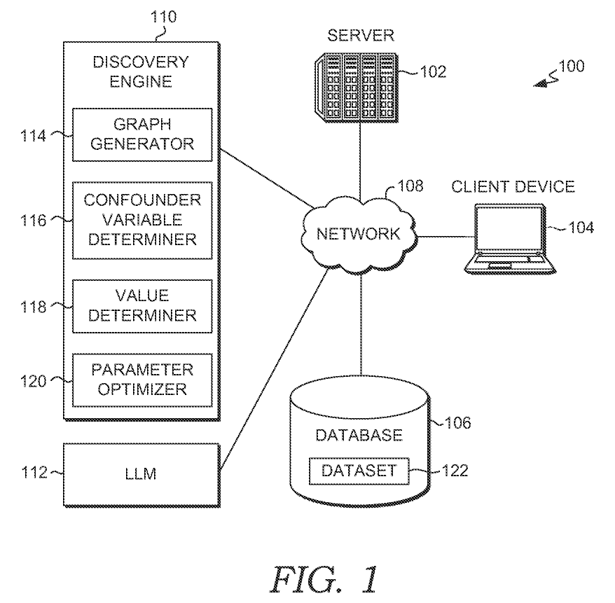

Referring initially to FIG. 1, an example operating environment 100 is provided. Operating environment 100 comprises server 102, client device 104, and database 106. Operating environment 100 further includes discovery engine 110 and LLM 112, which may be used by server 102, client device 104, or both.

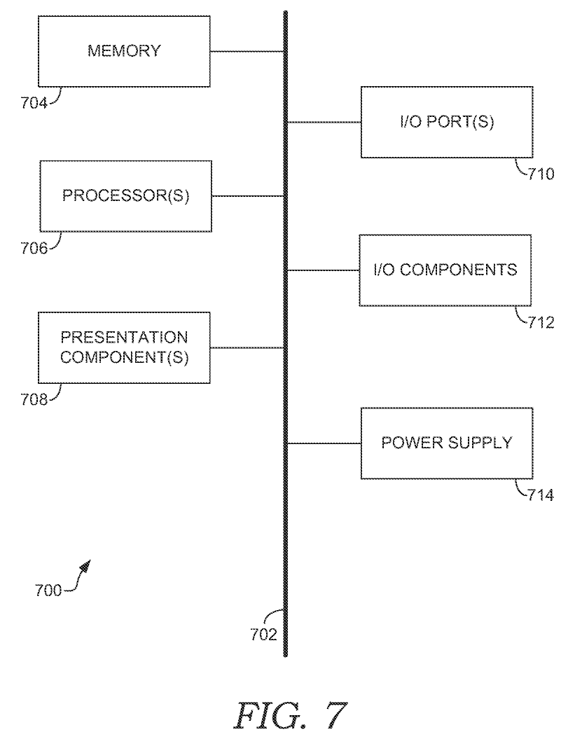

Generally, server 102 is a computing device that implements functional aspects of operating environment 100, such as one or more functions of discovery engine 110. One suitable example of a computing device that can be employed as server 102 is described as computing device 700 with respect to FIG. 7.

Client device 104 is generally a computing device, such as computing device 700 of FIG. 7. Client device 104 may perform various functions described herein. In aspects, client device 104 may perform functions described with respect to discovery engine 110.

As with other components of FIG. 1, server 102 and client device 104 are each intended to represent one or more devices. In implementations, client device 104 is a client-side or front-end device, and server 102 represents a back-end or server-side device. It will be understood that some implementations of the technology will comprise either a client-side or front-end computing device, a back-end or server-side computing device, or both, executing any combination of functions for document source detection. FIG. 1 is simply one example illustration of a computing environment in which the technology may be employed, although it will be recognized that other arrangements of devices and functions may be used with the technology as well. All are intended to be within the scope of the present disclosure, as will be further noted.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

With continued reference to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1 are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory.

Discovery engine 110 may be employed in coordination with an LLM 112 for general causal discovery of dataset 122. In general, dataset 122 may be a structured collection of data points. Such datasets may include variables (e.g., features) that have corresponding values, often measured, observed, or derived, which can have relationships or other correlations, including known or unknown causal links. These datasets can include data across one or more domains. A dataset, such as dataset 122, may include multiple variables associated with numerical, categorical, or textual values recorded across multiple instances. Dataset 122 may also encode relationships between the variables. For example, a wine dataset may include variables such as residual sugar, density, alcohol content, volatile acidity, total sulfur dioxide, and quality. Each variable corresponds to a measurable value for individual wine samples. The dataset may reveal relationships between variables, such as a potential correlation between total sulfur dioxide and quality, or the effect of alcohol content on density. Another example is a healthcare dataset, which might include variables such as patient age, body mass index (BMI), blood pressure, cholesterol levels, and disease diagnosis. Each variable captures characteristics of individual patients, and the dataset may highlight relationships, such as the link between elevated BMI and increased risk of hypertension. Yet another example is a climate dataset containing variables such as temperature, precipitation levels, wind speed, carbon dioxide (CO₂) concentration, and vegetation density over a specific geographic area. Each variable reflects observed environmental metrics, and the dataset can provide insights into the interdependencies among these factors, such as how CO₂ concentration influences temperature trends. These are just a few examples, and other datasets may be used as dataset 122 for causal discovery in coordination with LLM 112.

LLM 112 may generally be a type of artificial intelligence (AI) system configured to process, understand, and generate human language. Broadly, an LLM may comprise a neural network-based system trained on datasets containing linguistic data, such that LLM 112 is configured to perform a variety of language-related tasks like text generation, summarization, translation, question answering, and sentiment analysis.

In some aspects, LLM 112 may be built using a deep learning architecture, such as transformers. Its architecture may include, among other examples, mechanisms such as attention layers to weigh the relevance of different parts of input data, facilitating nuanced understanding, and response generation. Examples of LLMs include GPT (Generative Pre-trained Transformers) series, BERT (Bidirectional Encoder Representations from Transformers), and other models or model systems that may process, understand, and generate relevant outputs.

In some aspects, LLM 112 training involves the use of large-scale corpora comprising diverse text data, such as books, articles, websites, and other publicly available sources. These datasets may span one or more languages or domains to enhance versatility. During training, supervised or unsupervised learning methods are applied, depending on the objective and model.

In some cases, models may undergo pre-training and fine-tuning steps. During pre-training, an LLM may be exposed to unlabeled text data, learning to predict the next word in a sequence (or similar tasks) based on context. This stage may help the model develop a general understanding of grammar, syntax, semantics, and factual knowledge embedded in the training data. Afterward, during a fine-turning stage, the pre-trained model is further trained on smaller, task-specific datasets that may be labeled or curated. Fine-tuning aligns the model's general knowledge with specific applications, optimizing it for desired outputs. LLM 112 may include a model or model system that has undergone a general training or a combination of general pre-training and fine-tuning steps.

During implementation, LLM 112 may use retrieval-augmented generation (RAG), where the model is supplemented with access to external databases or structured data repositories. For instance, LLM 112 may be configured to access dataset 122.

In general, discovery engine 110 may work in coordination with LLM 112 to perform causal discovery on dataset 122. In the example illustrated by FIG. 1, discovery engine 110 comprises graph generator 114, confounder variable determiner 116, value determiner 118, and parameter optimizer 120. At a high level, discovery engine 110 executes such functional components to generate or otherwise access a causal graphical representation of dataset 122. LLM 112 can be deployed to identify a confounder variable and provide a value for the confounder variable. The confounder variable along with its provided value can undergo parameter optimization to determine a relationship strength between the confounder variable and another variable the dataset 122.

Graph generator 114 may be employed to generate a causal graphical representation that may be accessed by other components of discovery engine 110. A causal graphical representation may generally include a structure, or other representation thereof, that models relationships between variables of dataset 122. A causal graphical representation can include nodes that represent the variables and edges that identify relationships or interactions between the nodes (variables). Examples of such graphical representations include directed acyclic graphs (DAGs), undirected graphs, and mixed graphs. One particular subset of this class is causal graphs, which may model potential causal relationships among variables. One such example of a causal graph is the partial ancestral graph (PAG), which represents causal relationships while accounting for uncertainty or ambiguity in the causal structure due to hidden variables, called confounder variables.

Graph generator 114 may employ statistical methods, such as correlation, conditional independence tests, or other inferential techniques, to determine the nature of the relationships between variables within dataset 122. In aspects, graph generator 114 generates edges between nodes, which may include directed, undirected, or mixed edges. Graphically, these may be represented by different symbols or shapes. The edges therefore may encode relationships such as causality, association, or dependence between variables of dataset 122. The resulting graphical representation provides a structured model of the relationships among the variables, which can be used for further analysis by LLM 112, as will be further described.

In a specific case, graph generator 114 generates a partial ancestral graph. To do so, graph generator 114 may use an algorithm suitable to handle uncertainty in causal discovery. One suitable example may include the fast causal inference (FCI) algorithm, although others may be used or constructed. The output determines the connections and orientations of the edges in the graph, which represent the various types of relationships between the variables. Partial ancestral graphs may use a combination of directed edges, bidirectional edges, and edges with uncertain endpoints (e.g., circles) to encode potential causal relationships while acknowledging ambiguities caused by latent confounders or selection effects.

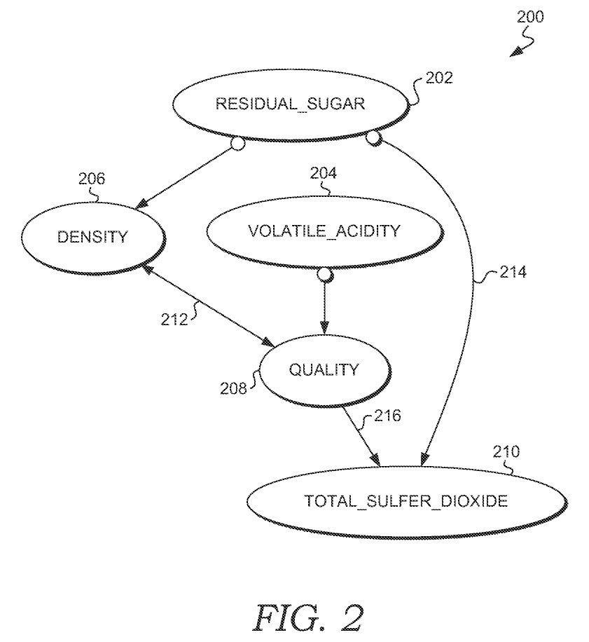

An example of such a partial ancestral graph that may be generated by graph generator 114 is illustrated in FIG. 2. While causal graphical representation 200 is graphically illustrated, it will be understood that causal graphical representations such as causal graphical representation 200 may be provided in another representation suitable for analysis by LLM 112, such as a textual description or another structured representation of the nodes and edges provided in causal graphical representation 200. As illustrated, causal graphical representation 200 comprises variable 202, variable 204, variable 206, variable 208, and variable 210. Each is connected by edges, such as bidirectional edge 212, edge 214, and edge 216.

While the graphical syntax may vary depending on a type of causal graphical representation generated by graph generator 114, in this partial ancestral graph example, a bidirectional arrow (↔), such as that illustrated by bidirectional edge 212, generally indicates that variable 206 and variable 208 are connected by a latent confounder representing an unmeasured common cause. For instance, the causal structure between variable 206 and variable 208 may not direct, but instead, it might be influenced by factors (the latent confounder variable) outside the observed data within dataset 122.

Also in this example, edges having a circle on one end and arrow on the other end (o→), such as edge 214, generally indicate uncertainty about the causal direction. These may be generated by graph generator 114 where there is some evidence suggesting variable 202 may influence edge 214, although the analysis cannot rule out other possibilities, and thus the direction of the influence may be unknown.

Additionally, in this example, a directed edge may be illustrated by a single arrow end (→), such as edge 216. The directed edges may indicate a known direct relationship determined from dataset 122. For instance, a directed edge indicates that A is a direct cause of B. In some cases, there is sufficient evidence from dataset 122 to support the causal relationship, such that no latent confounders are believed to influence this particular edge.

Confounder variable determiner 116 can be employed to access a causal graphical representation, such as causal graphical representation 200 generated by graph generator 114 to determine one or more latent confounder variables. LLM 112 may be used by confounder variable determiner 116 to determine a confounder variable. For example, a causal graphical representation, such as causal graphical representation 200, may be provided to LLM 112, and LLM 112 may be prompted to identify the confounder variable. In an aspect, a prompt comprises the input text, graph, or other query provided to LLM 112 to guide it. Prompts can range from simple questions to detailed instructions. “A prompt” generally is intended to mean one or more queries provided to an LLM to elicit a particular output.

In some implementations, LLM 112 is prompted to identify a confounder variable for two variables within the causal graphical representation that are connected by a bidirectional edge. In an aspect, the confounder variable is identified for a partial ancestral graph having at least two variables represented by a bidirectional edge. For instance, the two variables may have a dependent relationship represented by a bidirectional edge. As noted, a bidirectional edge may indicate the presence of a latent confounder influencing both variables. For instance, in the partial ancestral graph illustrated in FIG. 2, the bidirectional edge 212 between variable 206 and variable 208 suggests that an unmeasured common cause affects both variables. By prompting LLM 112 to identify the confounder variable for these two variables, the system can leverage the LLM's advanced language processing capabilities to hypothesize potential latent confounders. For instance, an LLM prompt may include instructions instructing LLM 112 to identify two variables within a causal graphical representation, such as causal graphical representation 200, having a bidirectional edge (or equivalent relationship), and to identify a potential latent confounder variable having a relationship with each of the two identified variables having the bidirectional edge. For example, this approach enhances the accuracy of causal discovery by addressing hidden variables that may otherwise obscure the true relationships between observed variables.

In some implementations, prompting LLM 112 further includes instructing the LLM 112 to maintain known dependent relationships within the causal graphical representation. As will be described, by maintaining known direct relationships between variables, the same direct relationships may be included in a second causal graphical representation generated by LLM 112. For example, if the initial causal graphical representation, such as causal graphical representation 200, includes a directed edge indicating a known causal relationship between two variables, such as the relationship represented by edge 216 between variable 208 and variable 210, LLM 112 may be instructed to identify such relationships and maintain them, such that the same direct relationships are included within a subsequently generated causal graphical representation. By maintaining these known dependencies, LLM 112 may focus on discovering new causal relationships without altering the established ones, thereby enhancing the accuracy and reliability of the causal analysis, and reducing the number of operations required by the computer, since the computer maintains the known relationships.

In some implementations, the causal graphical representation includes variables with causal relationships of unknown direction. As an example, for a partial ancestral graph, these direct relationships may be represented by edges having a circle on one end and arrow on the other end. For example, in the partial ancestral graph illustrated in FIG. 2, certain edges, such as edge 214, may indicate an uncertain causal direction between variable 202 and variable 210. For such relationships, the prompt provided to LLM 112 may include specific instructions to determine the direction of these causal relationships, thereby helping refine the causal structure, for example. As will be further described, in cases where LLM 112 generates a subsequent causal graphical representation, the direction determined by LLM 112 may be illustrated in the new causal graphical representation. By instructing LLM 112 to analyze these edges and determine the most likely direction of causality, the system can refine the causal graphical representation to provide clearer insights into the relationships between variables. This process leverages the analytical capabilities of LLM 112 to resolve ambiguities in the causal structure, thereby enhancing the overall accuracy and utility of the causal discovery system.

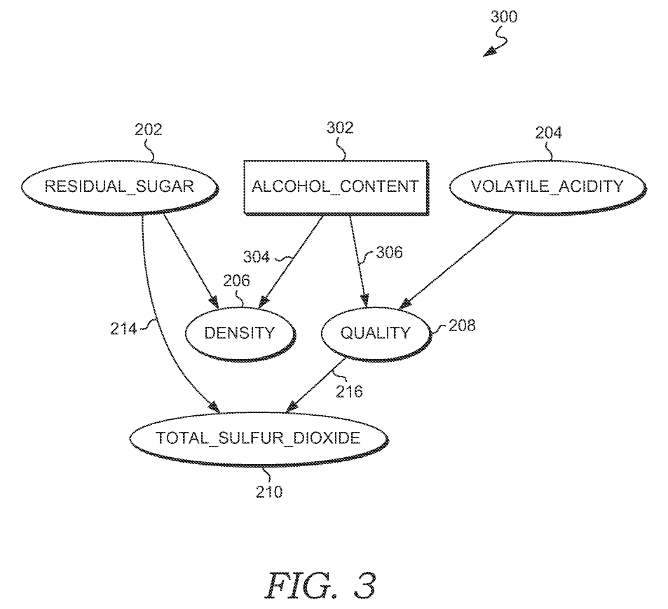

As noted, in some aspects, the output of LLM 112 responsive to confounder variable determiner 116 may be a second, or subsequent, causal graphical representation, such as is illustrated by causal graphical representation 300 of FIG. 3. In aspects, a prompt by confounder variable determiner 116 may instruct LLM 112 to generate a second causal graphical representation having a confounder variable determined by LLM 112.

The example causal graphical representation 300 of FIG. 3 provides an example of a second causal graphical representation that may be output by LLM 112. Causal graphical representation 300 may result from LLM 112 having been provided with causal graphical representation 200. Variable 202, variable 204, variable 206, variable 208, and variable 210 are present in causal graphical representation 300, and these may include the variables that were originally present in dataset 122. Causal graphical representation 300 further includes confounder variable 302, which was identified by LLM 112.

In the example of causal graphical representation 300, edge 216 has been maintained from causal graphical representation 200. In this case, LLM 112 maintains the known direct relationship between variable 208 and variable 210.

Additionally, in the example of causal graphical representation 300, LLM 112 has proposed directions for the relationships between variable 202 and variable 210 (represented by edge 214). Other directions of direct relationships are maintained between first causal graphical representation 200 and second causal graphical representation 300 and, edge 214 is one illustrated as an example, and others may not be further discussed for brevity. As noted, in causal graphical representation 200, there is a relationship between variable 202 and variable 210, although the direction of the relationship is unknown. Responsive to instructions of a prompt, LLM 112 has proposed a direction of the relationship, illustrated by edge 214 of FIG. 3.

Further, in the example of causal graphical representation 300, LLM 112 has proposed confounder variable 302. In this example, confounder variable 302 has direct relationships between the variables initially having a bidirectional edge in causal graphical representation 200 (variable 206 and variable 208, connected by bidirectional edge 212). Thus, LLM 112 may identify those variables having a dependent relationship that can be represented by a bidirectional edge and identify a confounder variable having a direct relationship to at least one or both of the variables. As shown in causal graphical representation 300, confounder variable 302 has a direct relationship with each of first variable 206 (edge 304, representing a first direct relationship) and second variable 208 (edge 306, representing a second direct relationship). Thus, generally, a confounder variable may be proposed having a direct relationship with another variable of dataset 122. In some cases, such as in the example illustrated, the initial bidirectional edge is removed between the two variables responsive to the confounder variable being proposed by LLM 112.

Having proposed a confounder variable, value determiner 118 may be employed to determine a value for the confounder variable, which as noted, may not have a corresponding value within dataset 122. This may be done by prompting the LLM to provide a value. In some cases, LLM 112 is instructed to provide a value and an error. In an aspect, the value is a mean value. In an aspect, the error is represented by a standard deviation of the value. As such, the value provided by the LLM may include a mean and standard deviation as parameters for the distribution of the confounder variable. For example, LLM 112 may rely on its training on diverse datasets to provide a value or the error. In some cases, LLM 112 can use contextual information and domain-specific knowledge embedded in its training data to provide the value or corresponding error. In some aspects, the LLM may access other external databases or sources of information to provide the value or error. By doing so, the LLM provides a value for the confounder variable that can be used in further causal analysis, helping to discover relationships that are as accurate and meaningful as possible.

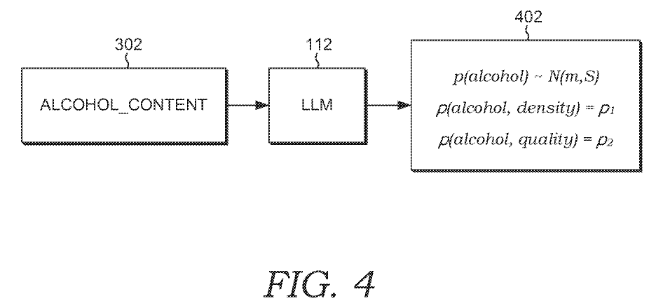

FIG. 4 is provided to illustrate an example in which LLM 112 determines a value and error. In this illustration LLM 112 is prompted with confounder variable 302 and an instruction to determine a value and error for the confounder variable 302. Output 402 is illustrative of an example output. In this case, LLM 112 has output a mean (m) value and an error (standard deviation, S) for the proposed alcohol content confounder variable 302. LLM 112 has also output a correlation between confounder variable 302 and variable 206 (ρ₁) and between confounder variable 302 and variable 208 (ρ₂).

Parameter optimizer 120 generally optimizes parameters for the variables of a causal graphical representation having a confounder variable, such as the causal graphical representation 300 of FIG. 3 for example. In general, parameter optimization for causal graphical representations, including partial ancestral graphs, includes refining the parameters that define the relationships between variables in the graph to best fit the observed data from dataset 122 and the value generated by LLM 112. In aspects, the strength of the causal relationships represented by the edges in the graph is determined as part of the optimization. Various optimization techniques, such as maximum likelihood estimation or Bayesian methods, may be employed to adjust the parameters to determine the relationship strength between variables, including variables of dataset 122 and the confounder variable proposed by LLM 112. As a result, parameter optimizer 120 determines the relationship strength between the confounder variable and another variable of dataset 122. In an aspect, parameter optimizer 120 determines the relationship strength between a confounder variable and another variable having a direct relationship with the confounder variable, as determined by LLM 112. In an aspect, parameter optimizer 120 determines the relationship strengths between all of the variables within the causal graphical representation from dataset 122, including the confounder variable.

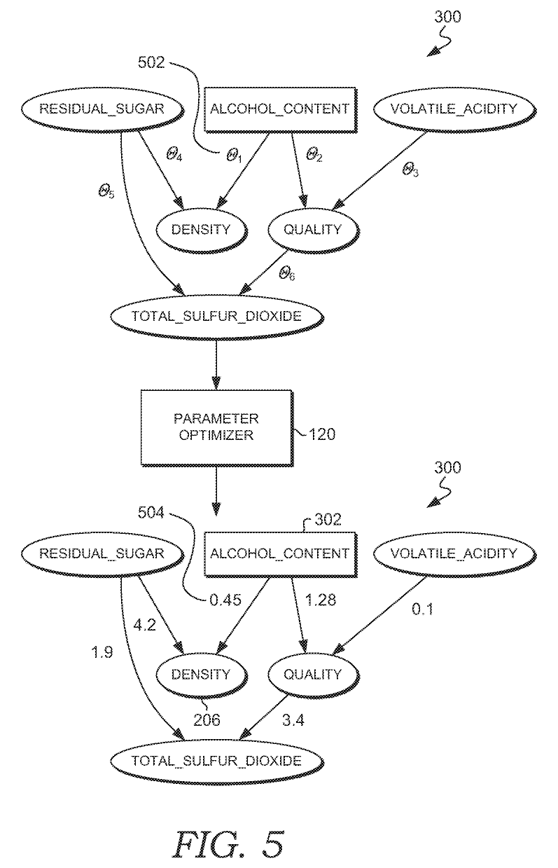

FIG. 5 illustrates an example in which parameter optimizer 120 is employed. In this example, the causal graphical representation 300 having the confounder variable is optimized to determine the relationship strengths between variables, represented in the graph as θ, such as pre-optimized or unknown relationship strength 502. The output of parameter optimizer 120 includes values corresponding to the relationship strengths between variables, such as relationship strength 504 between alcohol content (confounder variable 302) and density (variable 206).

The output relationships and relationship strengths determined by discovery engine 110 may be used to make decisions using a confounder variable or other variable within dataset 122. That is, in an aspect, a value of the confounder variable is modified to achieve a value of another variable according to the discovered relationship strength. In another aspect, the value of a variable is modified to achieve a value of the confounder variable according to the discovered relationship strength. Continuing with the example used throughout the application to help describe the technology, the alcohol content of a wine may be modified to achieve a particular density or quality. Other applications will be understood based on the data of dataset 122.

### Example Causal Discovery Method

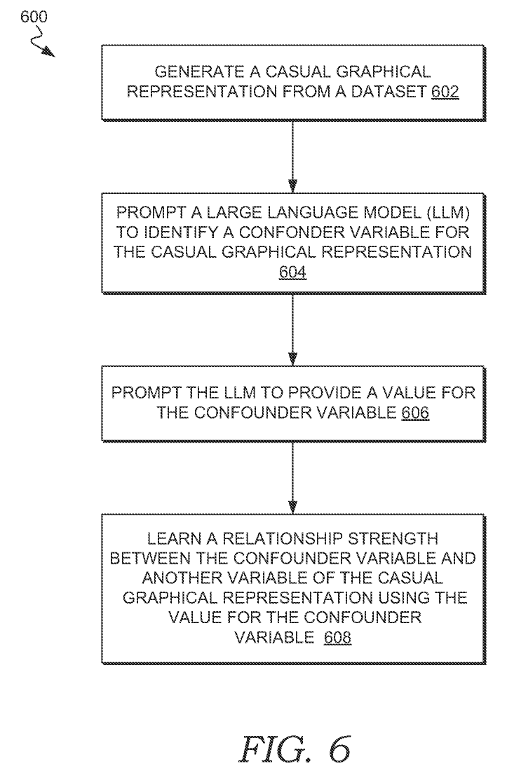

With reference now to FIG. 6, a block diagram is provided illustrating method 600 for identifying a confounder variable and its corresponding relationship strength to another variable. Each block of the method may comprise a computing process performed using any combination of hardware, firmware, or software. For instance, the method can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. The method may be implemented in whole or in part by components of operating environment 100, such as discovery engine 110.

In block 602, method 600 begins by generating a causal graphical representation from a dataset. In another aspect, a stored causal graphical representation is accessed. This causal graphical representation can take various forms, such as a PAG, DAG, or other types of causal graphs. The causal graphical representation may be constructed using graph generator 114 by identifying variables within the dataset and representing them as nodes. Relationships between these variables are provided as edges connecting the nodes. These edges can indicate various types of relationships, such as direct causality, associations, or dependencies. The initial or first causal graphical representation may serve as the basis for further analysis and discovery of causal relationships using discovery engine 110.

In block 604, method 600 prompts or otherwise instructs a large language model (LLM) to identify a confounder variable for the causal graphical representation generated in block 602. This may be performed, for instance, by confounder variable determiner 116. For example, in a partial ancestral graph, the LLM might be prompted to identify a confounder variable for two variables represented by or connected by a bidirectional edge, indicating a latent confounder.

In block 606, method 600 further prompts the LLM to provide a value for the confounder variable identified in block 604. The LLM may execute its training on general or specific domain corpora, and in some cases, may access external databases or sources of information to provide a plausible value for the confounder variable. This may be done by value determiner 118. The provided output may include statistical measures such as a mean value and a standard deviation. For instance, if the confounder variable is "alcohol content" in a wine dataset, the LLM might provide an average alcohol content value along with its variability. In some cases, LLM 112 outputs a second causal graphical representation having the confounder variable and representing the relationships, such as direct relationships, between the confounder variables and other variables in the graph determined from the dataset.

In block 608, method 600 learns the relationship strength between the confounder variable and another variable in the causal graphical representation from the dataset using the value for the confounder variable. This may involve parameter optimization techniques described with respect to parameter optimizer 120 to refine the parameters that define the relationships between variables in the graph. Methods such as maximum likelihood estimation or Bayesian methods may be employed to adjust these parameters, and to find a best fit for the observed values of the dataset and the values provided by the LLM. The relationship strength may quantify how changes in the confounder variable affect other variables in the graph or vice versa. For example, the relationship strength between "alcohol content" and "wine quality" might be determined, providing insights into how variations in alcohol content influence the overall quality of the wine.

### Example Operating Environment

Having described an overview of some embodiments of the present technology, an example computing environment in which embodiments of the present technology may be implemented is described below in order to provide a general context for various aspects of the present technology. Referring now to FIG. 7 in particular, an example operating environment for implementing embodiments of the present technology is shown and designated generally as computing device 700. Computing device 700 is but one example of a suitable computing environment and is not intended to suggest any limitation as to the scope of use or functionality of the technology. Computing device 700 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 702, which directly or indirectly couples the following devices: memory 704, one or more processors 706, one or more presentation components 708, input/output (I/O) ports 710, input/output components 712, and illustrative power supply 714. Bus 702 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 7 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 7 and with reference to “computing device.”

Computing device 700 typically includes a variety of computer-readable media. Computer-readable media can be any available media that can be accessed by computing device 700 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 700. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 704 includes computer storage media in the form of volatile or non-volatile memory. The memory may be removable, non-removable, or a combination thereof. Example hardware devices include solid-state memory, hard drives, optical-disc drives, etc. Computing device 700 includes one or more processors that read data from various entities, such as memory 704 or I/O components 712. Presentation component(s) 708 presents data indications to a user or other device. Example presentation components include a display device, speaker, printing component, vibrating component, etc.

I/O ports 710 allow computing device 700 to be logically coupled to other devices, including I/O components 712, some of which may be built-in. Illustrative components include a microphone, joystick, game pad, satellite dish, scanner, printer, wireless device, etc. The I/O components 712 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 700. Computing device 700 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 700 may be equipped with accelerometers or gyroscopes that enable detection of motion. The output of the accelerometers or gyroscopes may be provided to the display of computing device 700 to render immersive augmented reality or virtual reality. Power supply 714 may supply power to 700 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including," “having," and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train," when referring to training a machine learning model, may mean training an untrained model, further training a previously trained model, fine-tuning a pre-trained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:

Aspect 1: A computer-implemented method comprising: generating a causal graphical representation from a dataset; prompting a large language model (LLM) to identify a confounder variable for the causal graphical representation; prompting the LLM to provide a value for the confounder variable; and learning a relationship strength between the confounder variable and another variable of the causal graphical representation using the value for the confounder variable.

Aspect 2: Aspect 1, wherein the causal graphical representation comprises a bidirectional edge between two variables, and the confounder variable has a dependent relationship with the two variables.

Aspect 3: Aspect 2, wherein the LLM is prompted to identify a confounder variable for the two variables of the causal graphical representation based on the two variables having a bidirectional edge.

Aspect 4: Any of Aspects 1-3, wherein the LLM outputs a second causal graphical representation comprising the confounder variable, the second causal graphical representation identifying a direct relationship between the confounder variable and other variables of the causal graphical representation generated from the dataset.

Aspect 5: Aspect 4, wherein prompting the LLM further includes instructing the LLM to maintain known direct relationships within the causal graphical representation when generating the second causal graphical representation.

Aspect 6: Any of Aspects 1-5, wherein prompting the LLM to provide the value for the confounder variable comprises instructing the LLM to generate a mean and standard deviation for the distribution of the confounder variable.

Aspect 7: Any of Aspects 1-6, wherein the causal graphical representation is a partial ancestral graph, the partial ancestral graph comprising variables having causal relationships with an unknown direction, the prompt comprising instructions to determine a direction between the variables having causal relationships with the unknown direction.

Aspect 8: One or more computer storage media storing computer-readable instructions thereon that, when executed by a processor, cause the processor to perform a method comprising: generating a first causal graphical representation from a dataset; causing a large language model (LLM) to generate a second causal graphical representation having a confounder variable from the first causal graphical representation; causing the LLM to provide a value for the confounder variable; and performing parameter optimization on the second causal graphical representation using the value to determine a relationship strength between the confounder variable and another variable of the first causal graphical representation.

Aspect 9: Aspect 8, wherein: the first causal graphical representation is a partial ancestral graph having at least two variables with a dependent relationship represented by a bidirectional edge; and the confounder variable of the second causal graphical representation has a first direct relationship with a first variable of the two variables and a second direct relationship with a second variable of the two variables.

Aspect 10: Any of Aspects 8-9, wherein the LLM identifies a confounder variable for inclusion in the second causal graphical representation responsive to two variables in the first causal graphical representation having a dependent relationship representable by a bidirectional edge.

Aspect 11: Any of Aspects 8-10, wherein causing the LLM to generate the second causal graphical representation comprises instructing the LLM to maintain direct relationships determined for variables of the first causal graphical representation.

Aspect 12: Any of Aspects 8-11, further comprising causing the LLM to provide an error corresponding to the value for the confounder variable.

Aspect 13: Any of Aspects 8-12, wherein causing the LLM to generate the second causal graphical representation comprises instructing the LLM to determine a direction of a relationship for variables within the first causal graphical representation that has a dependent relationship of an unknown direction.

Aspect 14: Any of Aspects 8-13, wherein generating the second causal graphical representation comprises the LLM determining a direction of a direct relationship between the confounder variable and a variable of the first causal graphical representation.

Aspect 15: A system comprising: at least one processor; and one or more computer storage media storing computer-readable instructions thereon that, when executed by a processor, cause the processor to perform a method comprising: accessing a first causal graphical representation from a dataset; generating a second causal graphical representation having a confounder variable from the first causal graphical representation using a large language model (LLM); receiving a value for the confounder variable from the LLM; and optimizing parameters of the second confounder variable, the parameter optimization providing a relationship strength between the confounder variable and another variable of the first causal graphical representation.

Aspect 16: Aspect 15, wherein: the first causal graphical representation has at least two variables with a dependent relationship; and the confounder variable of the second causal graphical representation has a first direct relationship with a first variable of the two variables and a second direct relationship with a second variable of the two variables.

Aspect 17: Aspect 16, wherein: the dependent relationship of the two variables in the first causal graphical representation is representable by a bidirectional edge; and the confounder variable is determined by the LLM responsive to the two variables having the dependent relationship representable by the bidirectional edge.

Aspect 18: Any of Aspects 15-17, wherein the second causal graphical representation is generated to include direct relationships between variables provided within the first causal graphical representation.

Aspect 19: Any of Aspects 15-18, wherein: the first causal graphical representation comprises two variables having a dependent relationship of an unknown direction; and the second causal graphical representation identifies a direction of the dependent relationship between the two variables.

Aspect 20: Any of Aspects 15-19, wherein the parameter optimization provides a relationship strength between the confounder variable and the another variable based on an error corresponding to the value.

What is claimed is:

1. A computer-implemented method comprising:
generating a causal graphical representation from a dataset;
prompting a large language model (LLM) to identify a confounder variable for the causal graphical representation;
prompting the LLM to provide a value for the confounder variable; and
learning a relationship strength between the confounder variable and another variable of the causal graphical representation using the value for the confounder variable.

2. The method of claim 1, wherein the causal graphical representation comprises a bidirectional edge between two variables, and the confounder variable has a dependent relationship with the two variables.

3. The method of claim 2, wherein the LLM is prompted to identify a confounder variable for the two variables of the causal graphical representation based on the two variables having the bidirectional edge.

4. The method of claim 1, wherein the LLM outputs a second causal graphical representation comprising the confounder variable, the second causal graphical representation identifying a direct relationship between the confounder variable and other variables of the causal graphical representation generated from the dataset.

5. The method of claim 4, wherein prompting the LLM further includes instructing the LLM to maintain known direct relationships within the causal graphical representation when generating the second causal graphical representation.

6. The method of claim 1, wherein prompting the LLM to provide the value for the confounder variable comprises instructing the LLM to generate a mean and standard deviation as parameters of a distribution of the confounder variable.

7. The method of claim 1, wherein the causal graphical representation is a partial ancestral graph, the partial ancestral graph comprising variables having causal relationships with an unknown direction, the prompt comprising instructions to determine a direction between the variables having causal relationships with the unknown direction.

8. One or more computer storage media storing computer-readable instructions thereon that, when executed by a processor, cause the processor to perform a method comprising:
generating a first causal graphical representation from a dataset;
causing a large language model (LLM) to generate a second causal graphical representation having a confounder variable from the first causal graphical representation;
causing the LLM to provide a value for the confounder variable; and
performing parameter optimization on the second causal graphical representation using the value to determine a relationship strength between the confounder variable and another variable of the first causal graphical representation.

9. The media of claim 8, wherein the LLM refines relationships between variables of the first causal graphical relationship when generating the second causal graphical representation.

10. The media of claim 8, wherein the LLM identifies a confounder variable for inclusion in the second causal graphical representation responsive to two variables in the first causal graphical representation having a dependent relationship representable by a bidirectional edge.

11. The media of claim 8, wherein causing the LLM to generate the second causal graphical representation comprises instructing the LLM to maintain direct relationships determined for variables of the first causal graphical representation.

12. The media of claim 8, further comprising causing the LLM to provide an error corresponding to the distribution of the confounder variable.

13. The media of claim 8, wherein causing the LLM to generate the second causal graphical representation comprises instructing the LLM to determine a direction of a relationship for variables within the first causal graphical representation that has a dependent relationship of an unknown direction.

14. The media of claim 8, wherein generating the second causal graphical representation comprises the LLM determining a direction of a direct relationship between the confounder variable and a variable of the first causal graphical representation.

15. A system comprising:
at least one processor; and
one or more computer storage media storing computer-readable instructions thereon that, when executed by a processor, cause the processor to perform a method comprising:
accessing a first causal graphical representation from a dataset;
generating a second causal graphical representation having a confounder variable from the first causal graphical representation using a large language model (LLM);
receiving a value for the confounder variable from the LLM; and
optimizing parameters of the second confounder variable, the parameter optimization providing a relationship strength between the confounder variable and another variable of the first causal graphical representation.

16. The system of claim 15, wherein:
the first causal graphical representation has at least two variables with a dependent relationship; and
the confounder variable of the second causal graphical representation has a first direct relationship with a first variable of the two variables and a second direct relationship with a second variable of the two variables.

17. The system of claim 16, wherein:
the dependent relationship of the two variables in the first causal graphical representation is representable by a bidirectional edge; and
the confounder variable is determined by the LLM responsive to the two variables having the bidirectional edge.

18. The system of claim 15, wherein the second causal graphical representation is generated to include direct relationships between variables provided within the first causal graphical representation.

19. The system of claim 15, wherein:
the first causal graphical representation comprises two variables having a dependent relationship of an unknown direction; and
the second causal graphical representation identifies a direction of the dependent relationship between the two variables.

20. The system of claim 15, wherein the parameter optimization provides a relationship strength between the confounder variable and the another variable based on an error corresponding to the value.
